(19) United States
(12) Patent Application Publication
(10) Pub. No.: US 2014/0113541 A1
(43) Pub. Date: Apr. 24, 2014

(54) VENTILATION DEVICE FOR BUILDING EXTERIOR

(71) Applicant: Paul E. DRIER, II, Palgrave (CA)

(72) Inventor: Paul E. DRIER, II, Palgrave (CA)

(21) Appl. No.: 13/656,824

(22) Filed: Oct. 22, 2012

(51) Int. Cl. E06B 7/02; F24F 13/14

(52) U.S. Cl. 454/222; 454/314

(57) ABSTRACT

A ventilation device for mounting in a wall of a building includes a supporting framework adapted for mounting in the wall and forming an air flow passageway for flow from the exterior of the wall to an opposite side. A vent flapper is pivotally mounted in the framework for selective movement within the framework between a closed position where air flow through the passage is prevented and an open position where air flow is allowed. Thermal insulation material is fixedly mounted on or in the vent flapper and is arranged to extend across the air flow passage in the closed position of the vent flapper. A handle can be mounted on an interior-facing side of the flapper for moving it between the closed and open positions. An exemplarily version of the device includes a vent cover mounted on the supporting framework at an exterior end of the air flow passage.

### FIELD OF THE INVENTION

The invention relates to the field of ventilation devices for mounting in a wall of a building and vent flappers or covers for use with a ventilation system.

### BACKGROUND OF THE INVENTION

As is well known in the ventilation industry, there are a variety of ventilation devices that can be used to provide outside or external air to the interior of a building. A simple form of such a device is a movable window sash that can be pivoted or otherwise moved to an open position to allow outside atmospheric air to enter the building interior. However, there are known difficulties with current systems and methods for providing curtain walls and window walls mounted on the exterior of a building which arise from the need to provide fresh air ventilation through the curtain wall or window wall. Although fresh air can be provided in some of these known systems by opening a section of a curtain wall, the known ventilation systems can be problematic due to safety requirements. In particular, building codes for curtain walls and window systems may not allow a window to be opened beyond a certain specified distance due to safety concerns. The distance that the window sash can be opened may be as small as four inches and such a small distance may not allow adequate ventilation to enter the room or building.

Also providing a ventilation system that does not result in a large heat loss to the outside atmosphere in cold weather conditions can be a problem for a building owner or building user. For example, if the ventilation opening is only covered by a thin non-insulated panel during cold weather, there can be substantial heat loss from the building through the ventilation passage despite the panel cover or closure.

Another difficulty that can be encountered with known ventilation systems that extend through an exterior wall or roof is the possibility of moisture or rain entering through the ventilation passage and possibly causing damage to the interior of the building. Preferably therefore a ventilation system on an exterior building wall should provide some form of rain screen to prevent rain from entering the building even if the ventilation passage itself is open. Sound transmission through the ventilation system can also pose difficulties, particularly if the exterior of the building is likely to be exposed to fairly large sound volumes. Accordingly, it is desirable for a ventilation system that extends through an exterior wall to have some sound attenuating capability, particularly when the ventilation passage is closed.

U.S. Pat. No. 4,050,364 issued Sep. 27, 1977 to Gretsch-Unitas GmbH describes a ventilating device for mounting on a wall which has an air flow passage therethrough. This known device has a generally rectangular housing with a back wall which is mounted on brackets secured to the building wall interior. An insulation layer is secured to the top and bottom walls of the housing and to a movable cover, which is pivotal between open and closed positions and, in the open position, extends downwardly from the housing.

The present invention satisfies a previously unappreciated need for an improved ventilation device for mounting in a wall of a building, this device employing a vent flapper mounted in a supporting framework for selective movement within the supporting framework between a closed position and an open position where air can flow into the building interior. Thermal insulation material is fixedly mounted on the vent flapper to help prevent heat loss through the air flow passage.

### SUMMARY OF THE INVENTION

According to an exemplary embodiment of the present disclosure, a ventilation device for mounting in a wall of a building includes a supporting framework adapted for mounting in the wall and forming an air flow passage for flow of air from one side of the wall to an opposite side facing an interior space of the building. A vent flapper is pivotally mounted in the framework for selective movement within the supporting framework between a closed position where air flow through the passage is prevented and an open position where air flows through the passage is allowed. There is also a body of thermal insulation material fixedly mounted on the vent flapper and arranged to extend across the air flow passage in the closed position of the vent flapper. A handle is mounted on an interior side of a vent flapper for moving the vent flapper between the closed position and the open position.

In one exemplary version of this ventilation device, the vent flapper is elongate and extends between opposite flapper ends each of which is pivotally connected to a respective side of the supporting framework. This vent flapper has two longitudinal panel sections which extend substantially at all acute angle to each other as viewed from one end of the vent flapper.

According to another exemplary embodiment of a present disclosure, a vent flapper for use with a ventilation system is mountable in a wall of a building and is usable to open or close an air flow passage in the wall. The vent flapper includes two outer panel sections connected to one another along adjacent edges to form an exterior of the vent flapper and at least major portions of these panel sections extend at an acute angle to each other. There is a body of thermal insulation material connected to at least one of the outer panel sections. Two pivot mechanisms are arranged at opposite ends of the panel sections for pivotally mounting the vent flapper to respective support frame members so that in use the vent flapper can be pivoted between open and closed positions. A sealing flange extends along a distal edge of at least one of the two panel sections, the distal edge being spaced from the adjacent edges of the panel sections. The sealing flange is adapted to engage an elongate flexible seal of the ventilation system in a closed position of the vent flapper.

In one exemplary version of this vent flapper, the outer panel sections are made of metal and are integrally connection at the adjacent edges of the panel sections.

In another exemplary embodiment of the present disclosure, a curtain wall apparatus for mounting on an exterior of a building is capable of providing ventilation for an interior of the building. The apparatus includes a window framework for supporting at least two parallel spaced apart vision glass lights on the exterior of the building, this framework being adapted for mounting on the exterior and including a plurality of rigid elongate frame members connected together to form the framework. There is also a vent structure arranged on one side edge of the window framework and connected to the window framework on an outer side of one of the frame members located opposite to an inner side thereof that faces the space between the glass lights. The vent structure forms with the one frame member and air flow passage that during use of the curtain wall, extends from a first end at an exterior side of the curtain wall to a second end at an interior side of the curtain wall. The apparatus further has an insulated vent flapper mounted in the vent structure for pivotal movement between a closed position where air flow through the air flow passage is prevented and an open position where air flow through the passage is allowed.

In one exemplary version of this curtain wall apparatus, the vent flapper is elongate, is located below the window framework, and extends at least most of the horizontal width of the window framework.

These and other aspects of the disclosed ventilation device, vent flapper and curtain wall will become more readily apparent to those having ordinary scale in the aft from the following detailed description taking in conjunction with the drawings provided herewith.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying photographs, the latter being briefly described hereinafter.

### BRIEF SUMMARY OF THE DRAWINGS

The description herein makes reference to the accompanying drawings wherein like reference numerals refer to like parts throughout the several views and wherein:

FIG. 1 is a is a front view of part of a curtain wall of a building, this view showing several adjacent exterior glass lights;

FIG. 2 is a is an isometric exploded view taken from above showing components of a vision glass support system with a ventilation device at the bottom;

FIG. 3 is a vertical cross-section of a curtain wall construction taken perpendicular to the plane of the glass lights and showing a transverse cross section of a bottom support frame for the glass lights and a ventilation device;

FIG. 4 is a is an isometric exploded view taken from below and from the interior side, this view showing the ventilation device and an adjacent vertical support frame;

FIG. 5 is a FIG. 5 is a horizontal cross-section of a vertical support frame with a stub shaft mounted thereon;

FIG. 6 is a longitudinal side view of the support frame member of FIG. 5;

FIG. 7 is an isometric view of the ventilation device showing two spaced apart glass lights extending upwardly from the ventilation device, this view being taken from the exterior side and from above;

FIG. 8 is a vertical transverse cross-section of a bottom frame member for the two parallel glass lights and the ventilation device arranged below the frame member, this view showing a vent flapper in the closed position;

FIG. 9 is a vertical transverse cross-section similar to FIG. 8 but showing the vent flapper in the open position;

FIG. 10 is a detail side view illustrating two positions of the vent flapper and a ratchet mechanism at an end of the vent flapper, only a portion of the vent flapper being shown;

FIG. 11 is a detail view of one end of an inner section of an alternate form of vent flapper; and

FIG. 12 is a detail end view showing the inner section of FIG. 11 attached to another section of the flapper and also showing an attached layer of insulation.

### DETAILED DESCRIPTION OF THE ILLUSTRATIVE EMBODIMENT

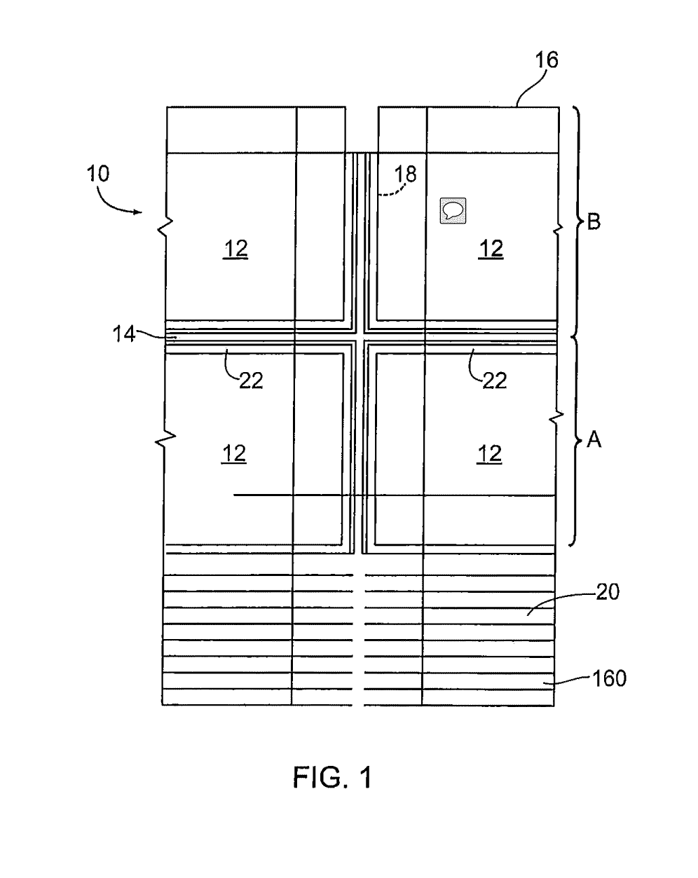

Illustrated in FIG. 1 is a portion of a curtain wall system 10 on a building exterior (not shown). A variety of curtain wall and window wall systems are known in the building art for both single story and multiple story buildings. For many applications, the curtain wall includes at least exterior glass panes or glass lights 12, several of which are shown in part in FIG. 1. There will generally be interior glass lights as well as described hereinafter, these lights extending parallel to or spaced apart from the exterior glass lights 12. These glass lights are mounted on a window framework indicated at 14 which can be used to support both the exterior and interior glass lights about their respective perimeters so that they are spaced apart by a suitable desiccated air space. The window framework is fixedly mounted on a supporting framework of the building which can include horizontal floor or roof beams 16 and vertically extending walls or pillars 18. Also on each floor of the building, there may be a lower section 20 of the curtain wall that is not covered on its exterior by glass lights. This lower section might, for example, be covered by metal panels, brickwork or wood members and air vents can be provided in the lower section, if required. In FIG. 1, there is also shown horizontally extending, intermediate window frame members 22 which extend along the top of the lower row A of exterior glass lights and along the bottom of an upper row B of exterior glass lights and which act to support both rows.

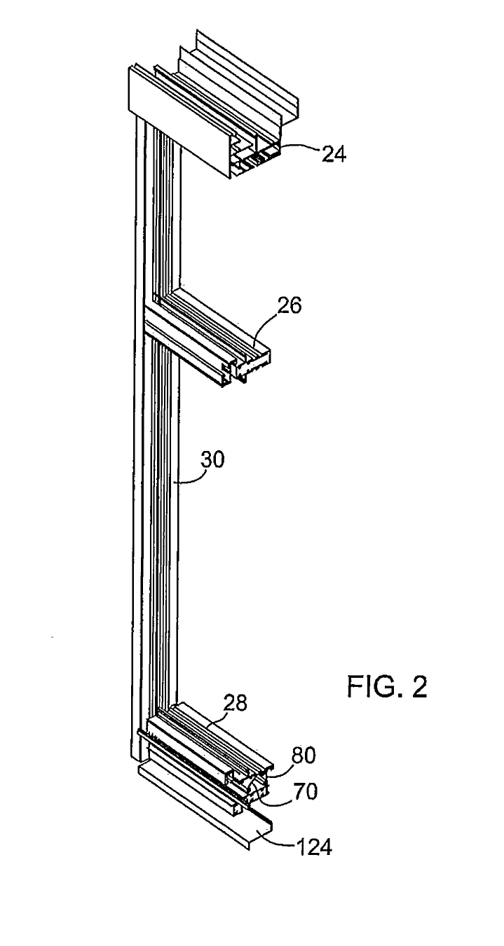

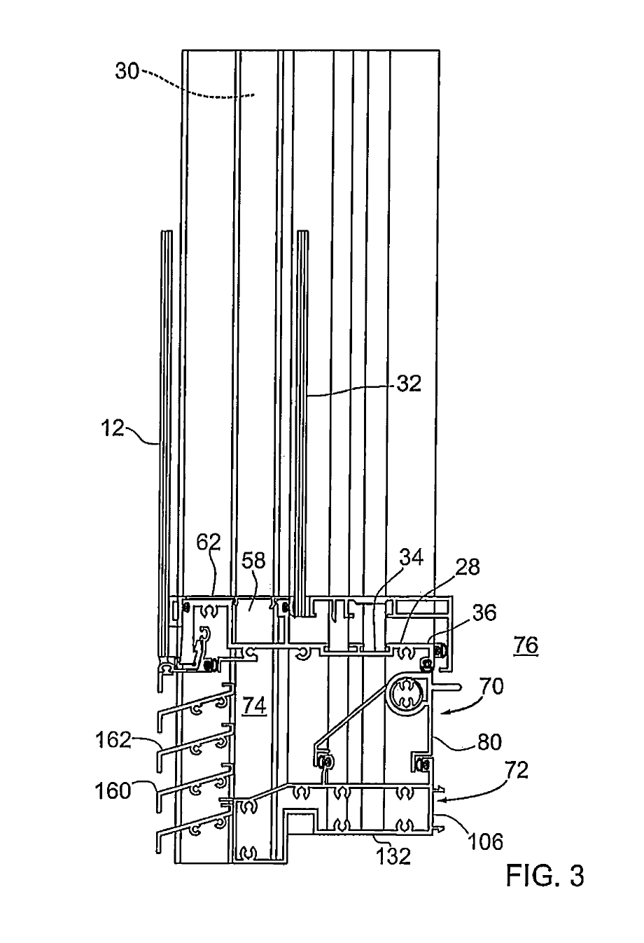

Turning now to the components of a vision glass support system or curtain wall illustrated in FIG. 2, located at the top of the system is a horizontal top or head frame member 24 which can be an extruded metal profile. Also shown is an intermediate, horizontal window frame member 26 which can support the bottom edge of a glass light located above it and the top of a glass light located below it. Partially shown at the bottom of FIG. 2 and shown in cross section in FIG. 3 is a bottom frame member or sill 28. Extending between the top frame member 24 and the bottom frame member is an elongate vertical side frame member or jamb 30 to which the frame members 24, 26 and 28 can be secured by screws in a manner known per se.

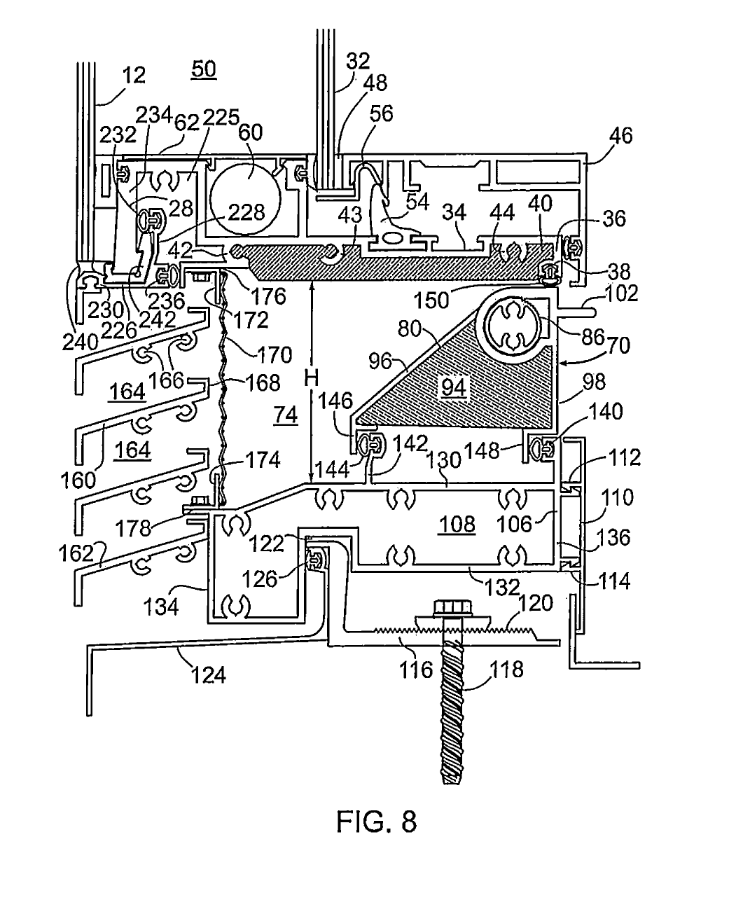

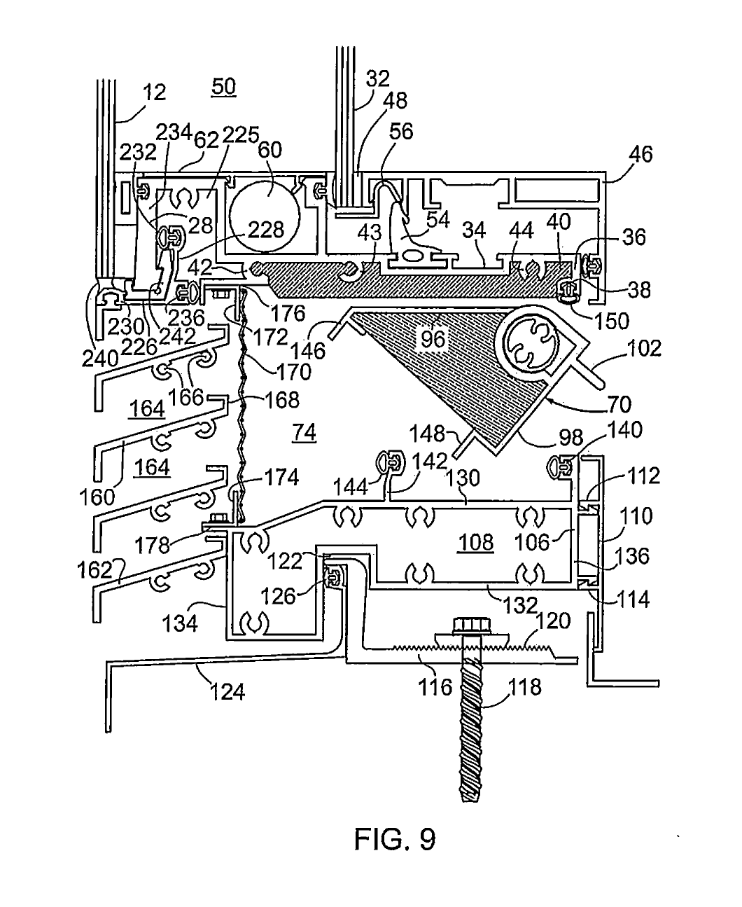

Turning now to the details of the bottom frame member shown in FIGS. 3, 4 and 7, this bottom frame member is an elongate metal profile member made of a suitable metal such as aluminum or aluminum alloy. In addition to the exterior glass light, the frame member 28 supports an interior glass light 32. The interior glass light can be supported along its bottom edge in the usual manner or in the manner illustrated herein and described further hereinafter. It is also possible for the interior and exterior glass lights to be connected together at their edges to form an insulated glass unit (IGU) in a manner known per se. The bottom frame member includes a main bottom wall 34 which generally extends perpendicular to the glass lights. An integral rear wall 36 extends downwardly from the inner longitudinal edge of the main wall and can have a connecting groove 38 formed along its bottom edge (see FIG. 8). If desired, a layer of insulation 40 can be mounted on the bottom surface of the main wall as shown in FIGS. 8 and 9. Curved screw races 42 to 44 can be integrally formed on the bottom surface of the main wall and are used to attach the frame member to the vertical frame members with the use of stainless steel screws. In the illustrated curtain wall construction there is an interior bottom frame member 46 which is mounted above the bottom flame member 28 and which forms the bottom section of a movable interior sash. A detailed description of this interior sash and its mounting mechanism is provided in applicant's co-pending U.S. patent application Ser. No. 13/629680 filed Sep. 28, 2012 and the description and drawings of that application are incorporated herein by reference. The interior frame member 46 can be attached by an adhesive strip 48 to the interior glass light 32. The interior glass light can be moved with the pivotal interior sash in order to gain access to desiccated air space 50 located between the two glass lights. A downwardly extending flange 52 formed on the interior frame member 46 engages a large gasket 54 that extends along the length of and is secured to the bottom frame member 28. Also shown in FIGS. 8 and 9 is an interior glass support 56 that engages and supports the interior light 32 at its bottom edge in a manner known per se. Generally, there are two of the supports 56 for each interior light, spaced apart a suitable distance.

The bottom frame member 28 forms a chamber 58 for desiccant material 60. The open top of this chamber is covered by a removable cover member 62 which can be made of a suitable resilient plastics material. After moving the aforementioned interior sash to an open position along with the interior glass light and removing the cover member 62, it is possible to replace the desiccant material and then cover the new body of desiccant material with the cover member,

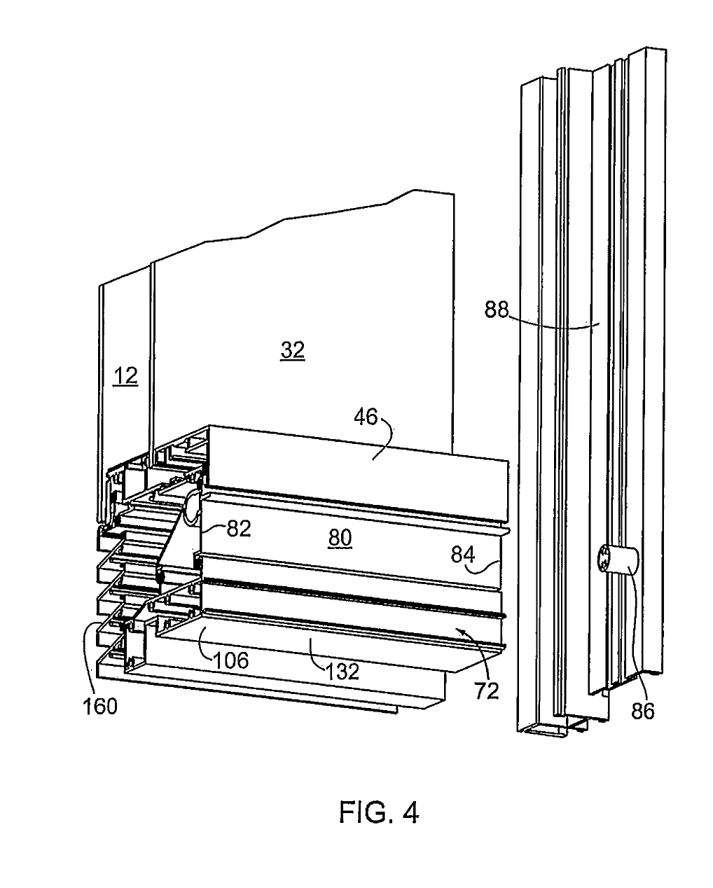

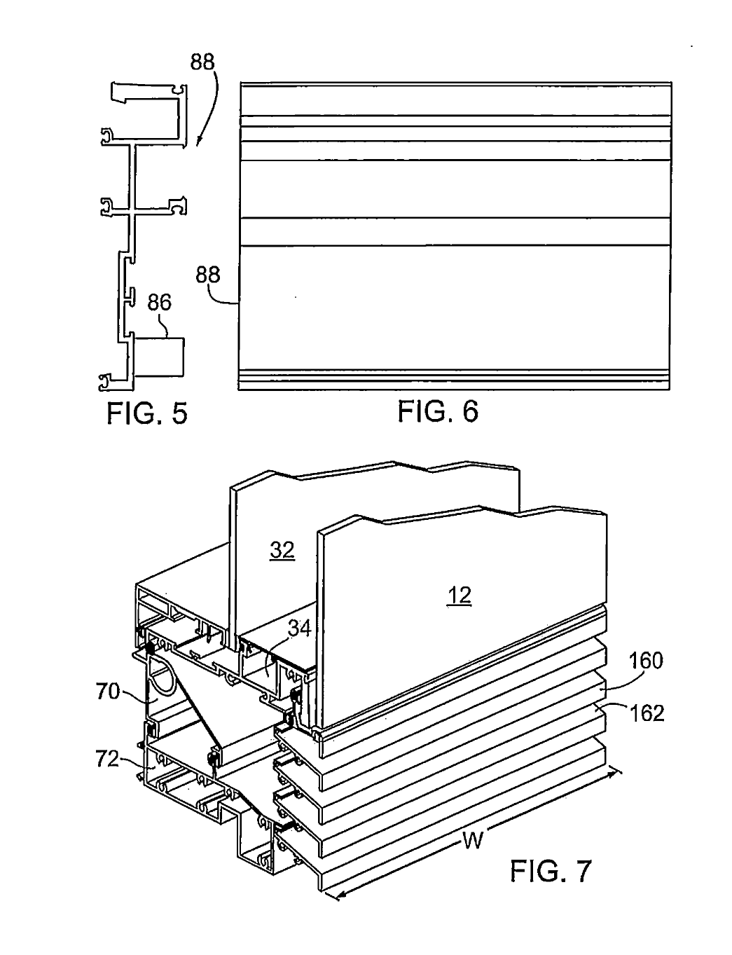

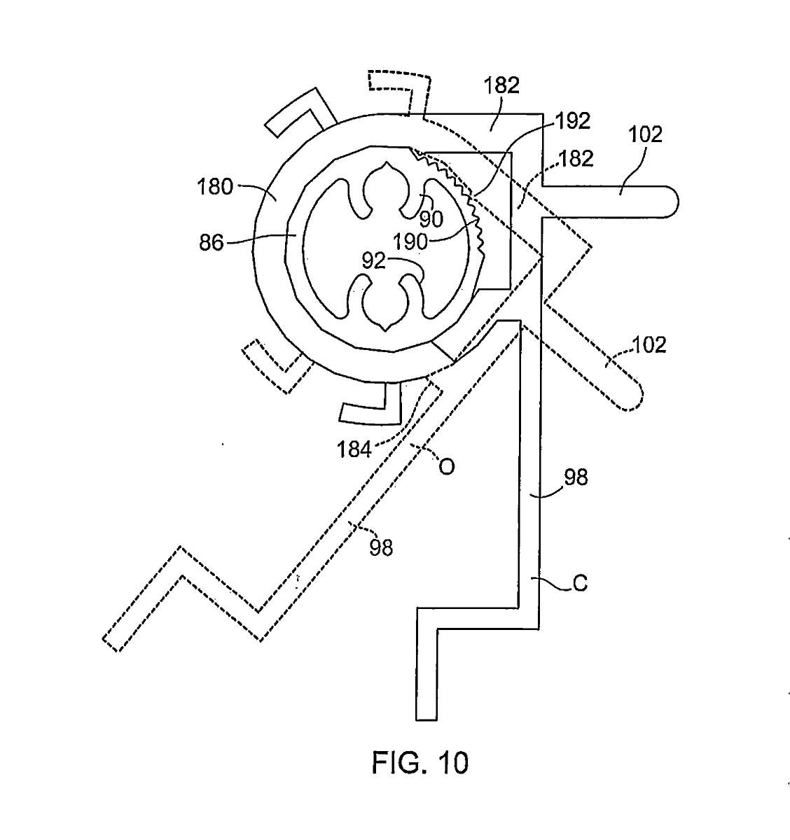

FIGS. 3, 4 and 7-9 illustrate a ventilation device constructed in accordance with the present disclosure and adapted for mounting in a wall of a building, this ventilation device being indicated generally at 70. The device includes a supporting framework indicated generally at 72 adapted for mounting in the wall and forming an air flow passage 74 for flow of air from one side of the wall to an opposite side facing an interior space indicated at 76 in FIG. 3. The air flow passage has height H which can vary to some extent and also a width indicated at W (see FIG. 7). The bottom frame member 28 of the window frame can form the upper part of the supporting framework 72. A vent flapper 80 is pivotally mounted in the supporting framework for selective movement within the supporting framework between a closed position illustrated in FIGS. 3 and 8 where air flows through the passage 74 is prevented and an open position shown in FIG. 9 wherein air flows through the passage is allowed. The vent flapper is elongate and its length extends horizontally in the illustrated embodiment. However, it will also be appreciated by those skilled in the ventilation art that it is possible for the present ventilation device to extend vertically along one side of a window, if desired. The vent flapper extends between opposite flapper ends 82 and 84 indicated in FIG. 4 and each end is pivotally connected to a respective side of the supporting framework by means of a cylindrical end plug 86. FIG. 4 illustrates one of the end plugs 86 mounted to a side frame member or jamb 88 which is a vertical portion of the window frame. In one exemplary embodiment the end plug 86 has a length of 75 mm and is attached by screws to the side frame member 88 using screw races 90, 92 (see FIG. 10).

An exemplary form of the vent flapper is insulated with a body of thermal insulation material 94 fixedly mounted on the vent flapper and arranged to extend across the air flow passage 74 in the closed position of the vent flapper as illustrated in FIG. 8. The insulation can be any of a variety of known insulating materials including solid foam insulation. Not only will the insulation help to reduce heat loss through the air flow passage but it can also act as a sound attenuator to reduce noise from the exterior of the building passing into the interior. The illustrated vent flapper has two longitudinal outer panel sections or walls 96, 98 which extends substantially at an acute angle to each other as viewed from one end of the illustrated vent flapper. In the illustrated embodiment this acute angle exceeds 45 degrees but is substantially less than 90 degrees. In the embodiment of FIGS. 8 and 9, the body of insulation material is arranged between the two longitudinal panel sections 96, 98 and indeed fills the space between these panel sections. However in the alternative embodiment illustrated in FIG. 12, there is a body of insulating material 100 which forms a uniform layer on the lower surface of the panel section 96′.

The ventilation device can also include a handle 102 which, as illustrated, can take the form of an integral flange arranged on an interior side of the vent flapper for moving the vent flapper between the closed position and the open position and optionally to an intermediate position as described below. The handle can extend most of the length of the vent flapper, if desired, or it can be a short member. The handle may comprise more than one handle formed on the flap member if desired, for example, one handle at each end of the flap member.

In the illustrated curtain wall construction, there is also an additional bottom frame metal member 106 which is separated from the bottom frame member 28 by the air flow passage 74 and the vent flapper. It should be appreciated that the bottom frame member 28 which is part of a window frame can also be described as an upper metal frame member since it is an upper part of the supporting framework for the ventilation device and is located above the bottom frame member 106. The frame member 106 has a hollow interior at 108 which can be filled with a suitable insulating material (not shown). The frame member 106 can be covered on its interior side by a relatively flat cover member 110 formed with a pair of resilient connecting hooks or flanges 112 and 114 arranged to detachably engage cooperating connecting hooks formed on the interior side of frame member 106. This cover member can be made of pultruded polyurethane that can be colored as desired to match the building interior.

The bottom support frame 106 can be secured in place by two or more angle-shaped anchor clips 116 that can be secured to the floor structure by means of screws or bolts 118. Each anchor clip is adjustable by means of micro serrations 120. In one particular embodiment, the amount by which each clip can be adjusted inwardly or outwardly of the building floor varies by + or −20 mm. An upper end of anchor clip fits into a downwardly facing channel 122 formed in the bottom of the frame member 106. Extending downwardly and forwardly from this channel is an extruded aluminum flashing 124. Mounted at the inner end of this flashing is an elongate, extruded silicone seal 126 that engages a vertical interior wall of the channel. This arrangement provides an effective means for preventing water and other moisture from entering the building at the bottom of the curtain wall.

The additional bottom frame member 106 includes a generally horizontal top wall 130, a bottom wall 132, an exterior, vertical wall 134 and a vertical interior wall 136. An upwardly projecting extension of the interior wall 136 supports an elongate, flexible seal 140 which can be mechanically secured along the top edge of the interior wall. Optionally, there can also be provided on the top wall 130 an upwardly extending support flange 142 on which can be mechanically mounted another flexible elongate seal 144. These seals 140 and 144 can extend the length of the vent flapper 80. These seals act to seal the bottom side of the front flapper in the closed position. The vent flapper 80 has at least one longitudinal edge flange for engaging a flexible seal when the vent flapper is in the closed position. However, in the exemplary illustrated embodiment there are two of these longitudinal edge flanges indicated at 146 and 148. The edge flange 146 can be an integral downward extension of the inner panel section 96. The edge flange 148 can be part of a right-angled flange formed on the bottom of the panel section 98. This right-angle flange initially extends inwardly into the air flow passage and then downwardly in the closed position of the vent flapper. An elongate, flexible seal 150 can also be provided at the top of the vent flapper. Thus, in the closed position of the vent flapper illustrated in FIG. 8, the edge flange 146 engages the elongate seal 144 while the edge flange 148 sealingly engages the seal 140 along its length. In the same closed position, the upper seal 150 engages the top of the vent flapper.

An exemplary form of the ventilation device includes a vent cover device mounted on the supporting framework. This vent cover device 160 is fixedly mounted on the exterior side of the curtain wall at the exterior end of the air flow passage 74. An exemplary form of the vent cover device comprises elongate, parallel slats 162 preferably made of a weather resistant material such as aluminum alloy or a suitable rigid plastic. As shown in the drawings, these slats extend horizontally in use and they are spaced apart from one another by gaps 164. At least a top surface of each slat slopes downwardly in the direction of the exterior of the curtain wall during use of the ventilation device. In this way rain water entering between the slats will tend to flow back towards the exterior. The slats can be connected at their opposite ends to vertical supports of the cover, if desired, or they can be connected directly to the side frame members 30 by means of stainless steel screws using the screw races 166. The inside edge of each slat can be formed with an upwardly and inwardly extending edge flange 168 to better prevent water from passing through the gaps 164.

The ventilation device can also be provided with a suitable screen 170 mounted in the supporting framework at an exterior end of the air flow passage 74 and extending across the height and width thereof. The screen helps prevent insects and other objects from passing through the vent cover and into the central region of the air flow passage. The upper and lower edges of the screen can be mounted on elongate metal brackets 172, 174. The upper bracket 172 can be secured by bolts or screws to a mounting flange 176 formed on the bottom of the main bottom wall 34 of the window frame member. The bottom bracket 174 can be connected by screws or bolts to a short corner flange formed at an outer corner of the bottom frame member 106.

FIG. 10 provides further details of the construction of the interior side of the vent flapper 80, that is, the side facing the building interior. This interior side is shown in the closed position indicated at C where the handle 102 and the longitudinal panel section 98 are not shown with crosshatching, and in the open position indicated at 0 where both the handle and the panel section 98 are shown with crosshatching. The panel section 96 has been omitted for ease of illustration in this figure. Provided at opposite end sections of the vent flapper are partial cylinders 180. One longitudinal edge of each partial cylinder is connected by a short, straight wall section 182 to the top edge of the panel section 98 while the other longitudinal edge of the panel partial cylinder is connected at 184 to the panel section 98. The partial cylinder and the short longitudinal wall at 182 define a passage which snugly receives the adjacent end plug 86, which is formed with a series of parallel grooves 190 on a portion of its exterior surface. These adjacent V grooves can be engaged by a single V-shaped ridge 192 that can be formed where the partial cylinder 180 is connected to the flat connecting wall 182. The V-shaped ridge 192 indexes into any selected one of the grooves on the end plug when the vent flapper 80 is rotated into one or more open positions. Thus, the combination of the series of grooves formed on the end plugs and the ridges form a ratchet mechanism that provides control of the position of the vent flapper. In this way, the user of the ventilation device can move the vent flapper from the fully closed to the fully open position if desired or he or she can move the vent flapper to any one of a number of partially open positions. In one particular embodiment of the ventilation device, the pivot mounting arrangement together with the ratchet mechanism allows the vent flapper to open as much as 40 degrees from its closed position.

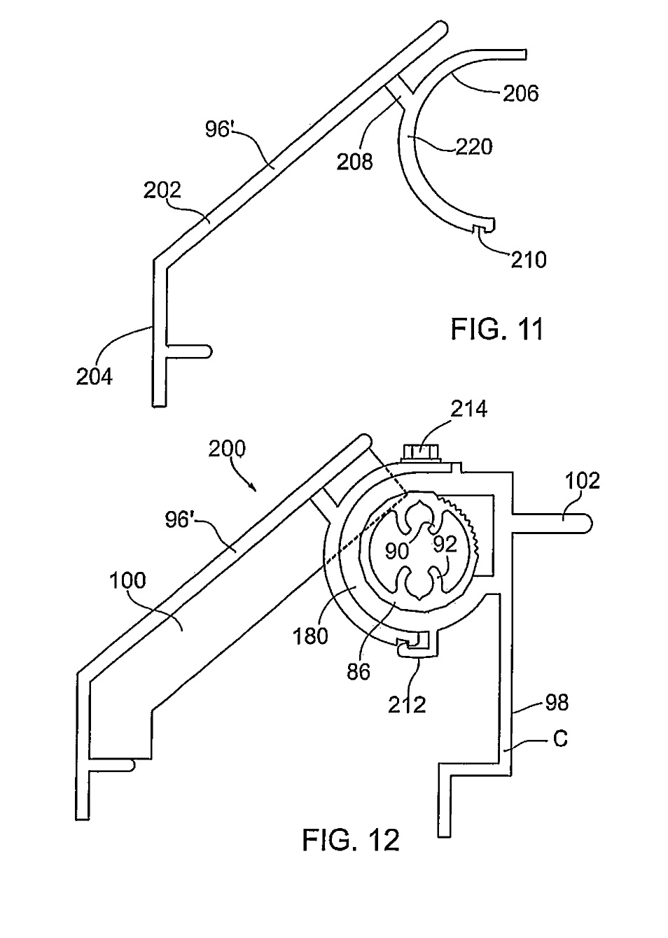

FIGS. 11 and 12 illustrate an alternate construction for the vent flapper, this alternate construction being generally indicated by reference 200. In this embodiment, the exterior of the vent flapper is constructed from two separate panel members that are connected to each other in addition to a layer of insulation material 100. An inner panel section 96′ is shown separately in FIG. 11 and it includes a main longitudinal panel section 202 that slopes downwardly towards the air flow passage when the vent flapper is closed and a short vertical panel section 204 that can be integrally connected to the section 202 at its lower edge. Mounted on the interior facing side of the panel section 202 is a semi-circular connector 206 with a short interconnecting wall 208 extending between it and the panel section 202. A connecting groove 210 can be formed along the bottom edge of the connector 206.

The panel section 98 is formed as a separate plastic or metal member with the handle 102. The panel section 96′ is connected to the panel section 98 by means of a hook connector 212 formed on the partial cylinder 180 described above. A hook or ridge at the end of the frame member engages into the groove 210 as shown in FIG. 12 while the upper end section of the semi-cylindrical connector 206 is secured by screws to the short flat wall at the top of panel section 98. The screws 214 can be M4 stainless steel machine screws arranged 450 mm on center with the initial screw being located 90 mm from the end of the vent flapper to avoid the end plug 86.

In order to provide sealing at the ends of the vent flapper the two opposite ends of the semi-cylindrical connector 206 can be milled back at the location 220 to allow for 3M (trade-mark) tape seals at the respective end which marry with the gasket seal that runs longitudinally along the top of the vent flapper.

It will be seen from the above description and the drawings that the ventilation device described herein is capable of being integrated with a curtain wall or window wall and being located at floor level forming the bottom section of the curtain wall or window wall. FIGS. 8 and 9 also show a system for providing a dead air space at the exterior end of the frame member 28. This dead air space 225 which is located between the exterior and interior glass lights is formed on three sides by a channel formed in the bottom frame member open on its bottom side. This open side is closed by a sealing strip device 226, only the transverse cross-section of which is shown. This device is constructed to close the dead air space without the need for screws and it is provided by an elongate metal strip having an angle-shaped transverse cross section. This metal strip can be made from a non-corroding metal such as aluminum or aluminum alloy and its length corresponds closely to the length of the adjacent glass edge. Two longitudinal sections 228, 230 of the device form an inside angle in a transverse plane of at least 90 degrees and, in an exemplary version, this angle ranges between 110 and 120 degrees. The first longitudinal section 228 extends into the elongate chamber formed by the channel while the second longitudinal section 230 extends to the edge of the exterior window glass for connection thereto by a suitable sealant adhesive. The strip device includes a first compression seal 232 mounted along the upper edge of the first longitudinal section. This seal can be a SCR compression gasket that extends the length of the strip device and that engages an inner surface of an exterior wall of the support flame member. The seal can be mechanically secured to the strip device as shown. A further SCR compression gasket 236 can be mechanically secured to the metal strip near the center of the strip device and is able to engage an edge flange of the frame member 28. The distal edge of the longitudinal section 230 can be sealingly attached to the adjacent exterior window glass by a seal 240 in the form of a two-part structural silicon adhesive.

The sealing strip device enclosing one side of the dead air space 225 can be mounted to the window frame 28 by means of two or more plastic clips 242 which can be made of polyvinylchloride (PVC) and thus are resilient and flexible. The use of these clips provides both a thermal break for the strip device and an acoustical break. The clip devices can snap over ridges formed along the bottom edge of the exterior wall 234. Each clip has an angle-shaped transverse exterior cross section similar to the adjacent interior surface of the metal strip. The clips 242 and the metal strip device are held together using “counter compressive” snaps in their exemplary form, this form of connection forming a relatively strong, permanent connection. The aforementioned co-pending U.S. patent application Ser. No. 13/629,680 provide further details concerning the sealing strip device and the clips 242 and the description and drawings of same are incorporated herein by reference.

While the present invention has been illustrated and described as embodied in exemplary embodiments, e.g. embodiments having particular utility for a ventilation device or system for a curtain wall or window wall, it is to be understood that the present invention is not limited to the details shown herein, since it will be understood the various omissions, modifications, substitutions and changes in the forms and details of the disclosed devices and systems may be made by those skilled in the art without departing in any way from the spirit and scope of the present invention. For example, those of ordinary skill in the art will readily adapt the present disclosure for various other applications without departing from the spirit or scope of the present invention.

What is claimed is:

1. A ventilation device for mounting in a wall of a building, said ventilation device comprising:
a supporting framework adapted for mounting in said wall and forming an air flow passage for flow of air from one side of the wall to an opposite side facing an interior space of the building;
a vent flapper pivotally mounted in said framework for selective movement within the supporting framework between a closed position where air flow through said passage is prevented and an open position where air flow through said passage is allowed;
a body of thermal insulation material fixedly mounted on said vent flapper and arranged to extend across the air flow passage in the closed position of the vent flapper; and
a handle mounted on a building interior-facing side of the vent flapper for moving the vent flapper between the closed position and the open position.

2. The ventilation device of claim 1 wherein said vent flapper is elongate and extends between opposite flapper ends each of which is pivotally connected to a respective side of the supporting framework and wherein said vent flapper has two longitudinal panel sections which extend substantially at an acute angle to each other as viewed from one end of the vent flapper.

3. The ventilation device of claim 2 wherein said body of thermal insulation material is arranged between the two longitudinal panel sections.

4. The ventilation device of claim 1 wherein said supporting framework is adapted for use in a curtain wall of the building and includes an upper metal frame member and a bottom metal frame member separated from said upper metal frame member by said air flow passage and the vent flapper.

5. The ventilation device of claim 4 including a vent cover device mounted on said supporting framework at an exterior end of the air flow passage, said vent cover comprising elongate, parallel slats which extend horizontally in use and are spaced apart from one another, at least a top surface of each slot sloping downwardly in the direction of the exterior of said wall during use of the ventilation device.

6. The ventilation device of claim 5 including a screen mounted on the supporting framework at an exterior end of the air flow passage and extending across a height and width thereof.

7. The ventilation device of claim 1 wherein said vent flapper has at least one longitudinal edge flange for engaging a seal when the vent flapper is in the closed position.

8. The ventilation device of claim 8 wherein said supporting framework includes a bottom metal frame member and an elongate flexible seal is mounted on said bottom metal frame member and arranged to engage sealingly said at least one longitudinal edge flange when the vent flapper is in the closed position.

9. A vent flapper for use with a ventilation system mountable in a wall of a building, said vent flapper being usable to open or close an air flow passage in said wall and comprising:
two outer panel sections connected to one another along adjacent edges to from an exterior of the vent flapper, at least major portions of the panel sections extending at an acute angle to each other;
a body of thermal insulation material connected to at least one of the outer panel sections;
two pivot mechanisms locate at opposite ends of the panel sections for pivotally mounting said vent flapper to respective support frame members so that in use said vent flapper can be pivoted between open and closed positions; and
a sealing flange extending along a distal edge of at least one of said two panel sections, said distal edge being spaced from said adjacent edges,
wherein said sealing flange is adapted to engage an elongate flexible seal of the ventilation system in the closed position of the vent flapper.

10. The vent flapper of claim 9 wherein said outer panel sections are made of metal and are integrally connected at said adjacent edges.

11. The vent flapper of claim 10 wherein said acute angle is at least 45 degrees.

12. The vent flapper of claim 9 wherein there is a respective one of the sealing flange extending along the distal edge of each of the two panel sections.

13. The vent flapper of claim 10 including a handle connected to one of said outer panel sections so as to project away from the insulation material, wherein said handle can be used to manually pivot the vent flapper between its open and closed positions.

14. The vent flapper of claim 9 wherein at least one of the pivot mechanisms includes a ratchet device capable of holding the vent flapper in a desired intermediate position between the open and closed positions.

15. A curtain wall apparatus for mounting on an exterior of a building, said curtain wall apparatus being capable of providing ventilation for an interior of the building and comprising:
a window framework for supporting at least two parallel, spaced-apart vision glass lights on the exterior of the building, said framework being adapted for mounting on said exterior and including a plurality of rigid, elongate frame members connected together to form the framework;
a vent structure arranged on one side edge of said window framework and connected to said window framework on an outer side of one of said frame members located opposite to an inner side thereof that faces the space between the glass lights, said vent structure forming with said one frame member an air flow passage that, during use of said curtain wall, extends from a first end at an exterior side of the curtain wall to a second end at an interior side of the curtain wall; and
an insulated vent flapper mounted in said vent structure for pivotal movement between a closed position where air flow through said air flow passage is prevented and an open position where air flow through the passage is allowed.

16. The curtain wall apparatus according to claim 15 wherein said vent flapper is elongate, is located below said window framework, and extends at least most of the horizontal width of the window framework.

17. The curtain wall apparatus according to claim 16 wherein said vent flapper is elongate and has two longitudinal panel sections, which extend substantially at an acute angle to each other as viewed from an end of the vent flapper, and wherein insulation material is secured to and covers at least most of at least one of the longitudinal panel sections.

18. The curtain wall apparatus according to claim 15 wherein said vent structure includes a vent cover located at said first end of the air flow passage and comprising elongate, parallel slats which extend horizontally in use and are spaced apart by ventilation slots.

19. The curtain wall apparatus according to claim 17 wherein said vent structure includes an elongate bottom frame member having at least one upwardly projecting longitudinal flange and an elongate seal mounted on said flange and arranged to sealingly engage said vent flapper in said closed position.

20. The curtain wall apparatus according to claim 15 including an elongate flexible seal mounted on said one frame member and in sealing engagement with said vent flapper in the closed position.
